(19) United States
(12) Patent Application Publication
(10) Pub. No.: US 2022/0159381 A1
(43) Pub. Date: May 19, 2022

(54) OVER-EAR HEADPHONES HAVING SPEAKER UNITS EQUIPPED WITH SURROUND SOUND MEMBERS

(71) Applicant: Mehmet Tunc TURGUT, Istanbul (TR)

(72) Inventor: Mehmet Tunc TURGUT, Istanbul (TR)

(21) Appl. No.: 17/436,622

(22) PCT Filed: Mar. 5, 2020
(86) PCT No.: PCT/TR2020/050177

§ 371 Date: Sep. 6, 2021

(30) Foreign Application Priority Data
Mar. 6, 2019 (TR) 2019/03435

(51) Int. Cl. H04R 5/033; H04R 1/10

(52) U.S. Cl. CPC H04R 5/033; H04R 2420/09; H04R 1/1008

(57) ABSTRACT

Over-ear headphones having speaker units peripherally provided with sound transmitter means to create surround sound effects in an ear unit provided within over-ear headphones. As when the speaker units provided with the surround sound transmitter means are used in the ear unit, a surround sound is created inside of the over-ear headphones, and hence a higher-performance sound is achieved in the over-ear headphones.

### CROSS REFERENCE TO THE RELATED APPLICATIONS

This application is the national stage entry of International Application No. PCT/TR2020/050177, filed on Mar. 5, 2020, which is based upon and claims priority to Turkish Patent Application No. 2019/03435 filed on Mar. 6, 2019, the entire contents of which are incorporated herein by reference.

### TECHNICAL FIELD

The present invention relates to an over-ear headphone assembly that contains speaker units equipped with surround sound elements in order to establish surround sound in the ear unit of the headphone.

As the usage of speaker units that have been equipped with surround sound within the ear unit shall allow the creation of surround sound in the headphones, it shall be possible to create high-performance sound inside the headphones.

Besides the headphone mechanism being suitable to be worn over the ears of the user to be listened to individually, the placement surfaces of the speakers within the headphones can be opened for the sound to be audible to the environment that the user is located in. Therefore, the embodiment subject to the invention can be used independently from the headphones.

### BACKGROUND

Today, as personal digital devices are being used prevalently, the usages of headphones that are used with such devices have also increased. While the headphones are meant to let users experience an individual listening session they are also expected to offer a variety of sound options.

Particularly, the headphones that are called over-ear headphones that rest on the ears by surrounding them have been provided with different sound units to ensure different sound options for users.

For example, the headphones have been provided with center, sub, front, and surround sound transmitters positioned on the speaker portions of the headphones to allow a user to experience 5.1 surround sound (multi-channel surround sound effect). Through these components, the headphones enable the user to experience 5.1 surround sound.

However, this and a couple of similar features are required to be operated by the use of a great number of different speaker components and/or parts. 5.1 surround sound experience and similar sound effects basically aim to create a variety of surround sound effects on the user's ears. In the prior art, such effects can only be created through the use of more than one speaker unit or component.

When it is considered that headphones have limited sizes since every additional component to be added to the headphones shall cause the headphone to be much larger in size, this would create a serious problem for both manufacturers of headphones and their users.

The headphones that have already been used are intended to create sound at the ear portions of the headphones. It is not desired to create sound in other directions as it is considered unnecessary to do so. On the other hand, if the sound is created toward the directions away from the ear, different types of sound effects can be created. Therefore, it is not possible to simply create the sound effects that may occur as a result of a possible spreading of sound in different directions with the current headphone systems.

Users now generally wish to use a single headphone they have purchased for different kinds of purposes. However, as different use areas require different features of headphones, the desired performance may not often be provided during use.

In such cases, the user may have to purchase different types of headphones for listening to music, watching a movie, playing a game, communication (wired/wireless), and stage performances (monitoring/DJ) separately.

For an instance, a user willing to listen to music would wish to have headphones with a powerful bass system, while another user who wishes to watch a movie or to play a game would probably request a headphone featuring a greater 5.1 sound effect. In such a case, the user would need to buy and keep more than one headphone.

Similarly, a user who owns headphones having an inadequate level of frequency range/response (Hz) or sound sensitivity (db) but desires to have headphones of higher capacity needs to throw away their current headphones and to buy new headphones.

A user who wants to purchase headphones having different sound features would need to relatively increase their budget to meet the cost of such systems as technical features of the systems are enhanced. Therefore, consumers are mostly prone to prefer headphones with low cost by taking such economic differences into account during purchasing. After use, if the user requests the headphones with sound features of higher quality, the user needs to set aside their current headphones and buy new headphones.

### SUMMARY

An aim of the invention is to provide over-ear headphones that enable surround sound effects to be created in the headphones by providing speaker units inside the headphones, wherein said speaker units have speaker sound transmitter means on at least a portion of the speaker units.

Said speaker unit also has geometric structures thereon that are designed to be suitable to allow the surround speaker sound transmitter means to be formed on said speaker units.

Therefore, even if a single speaker unit is used for every ear unit inside the headphones, surround sound effect can still be transmitted to the user's ear. To produce the headphones that are able to create sound effects at different levels, the number or the power of the speaker units used in the ear unit is increased and hence the performance of the system can be enhanced.

In an attempt to create surround sound in the headphones by using one speaker unit, the headphones subject to the invention will both reduce the cost of the headphones and also allow the headphones to be operated with a lower risk of malfunctioning.

With the use of the headphones subject to the invention, it would be possible to create a sound not only on the direction of the user's ear but in other directions as well. Therefore, different sound effects can be transmitted to the user's ears. This may allow the sound to travel around the headphones.

Thus, for the requirements of different sound levels and effects, modular headphone systems can be produced with satisfactory sound and effect capabilities by placing different sound and effect means in the openings formed on the same headphones, without the need for purchasing new headphones.

The headphones are designed to be suitable to rest on the user's ear and to allow the user to experience individual listening sessions, and additionally, the speaker placement openings provided on the headphones can be opened and the sound can be enabled to be audible from the environment in which the user is located.

On the other hand, the speaker units that can be used for connection to the headphones may also be used for emitting the sound in an external environment. The speaker units can still be used externally without the headphones.

### BRIEF DESCRIPTION OF THE DRAWINGS

FIG. 1 shows a perspective view of the headphones having a single speaker unit

FIG. 2 shows a perspective view of the headphones having three speaker units

FIG. 3 shows a perspective view of the speaker unit having a cylindrical shape

FIG. 4 shows a perspective view of the speaker unit having a prism shape

FIG. 5 shows a perspective view of the headphones having three placement openings that are designed to have a circular shape

### DEFINITIONS OF THE REFERENCES IN THE DRAWINGS

1. Ear unit
2. Headband
3. Ear cushions
4. Ear cups
5. Speaker unit
   5.1. Speaker sound transmitter means
6. Placement opening

### DETAILED DESCRIPTION OF THE EMBODIMENTS

The over-ear headphones are basically formed of; ear units (1) located at two opposite ends of the elastic headband (2), speaker units (5) positioned in said ear units (1) to transmit sound toward the ear cup (4).

The headphones can also be provided with a transmission wire or a wireless connection unit to communicate with the sound transmitter means.

The ear cushion (3) defines the part that is formed around the ear units (1) and mostly ensures sound isolation. The ear cushion (3) also enables the ear unit (1) to be placed without hurting the ears and other areas near the ears.

The headphones subject to the invention have, at least a speaker unit (5) that has been provided with a speaker sound transmitter means (5.1) having at least one peripheral portion in every ear unit (1) to allow the user to experience surround sound properly, wherein said speaker unit is provided on the ear cup (4) of the ear unit (1).

Said speaker units (5) may be mounted on the ear unit (1) in an undetachable manner.

Said speaker units (5) have been designed to be in geometric shapes suitable to allow the peripheral speaker sound transmitter means (5.1) to be formed on said speaker units. As the speaker units that are designed to be in a prism, cylindrical or spherical shape enable the speaker sound transmitter means to be peripherally formed on said speaker units, these speaker units can be an example of the embodiments that are suitable to be designed in such geometric shapes.

The headphones subject to the invention are provided with speaker sound transmitter means (5.1) that are peripherally formed on at least one portion of the speaker unit (5) in the interior portion of said headphones as the headphones are intended to transmit surround sound effect to the user's ear. According to various embodiments of the invention, the entire peripheral surface of the speaker unit (5) may be provided with speaker sound transmitter means (5.1).

FIG. 3 illustrates a speaker unit (5) that is designed to be cylindrical. With reference to FIG. 3, lateral walls of the speaker unit (5) having a cylindrical shape is equipped with the speaker sound transmitter means (5.1) peripherally provided thereon.

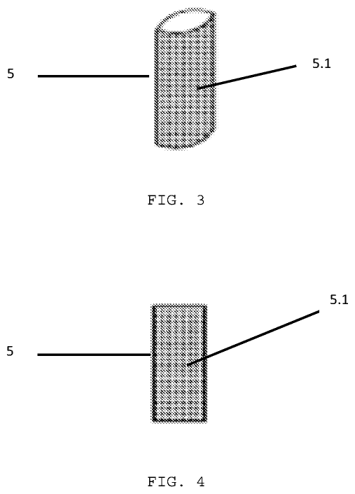

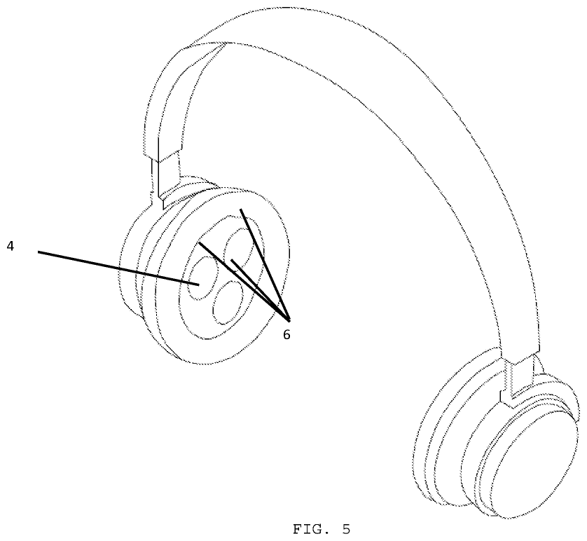

Similarly, FIG. 4 can be an example of the speaker units (5) that are designed to be in prism shape such that surround sound effect can be created.

The speaker unit (5) subject to the invention is intended to create a sound ear unit (1) not only toward the direction of the user's ear but also in other directions. The sound created in the other directions outside the user's ear can be oriented toward the user's ear after these sounds are reflected from other components of the headphones. The sound effect transmitted to the user's ear with the spreading of the sound in an environment and the reflection of this sound from a wall is indeed intended to be created inside the headphones.

On the other hand, if every ear unit (1) has at least a speaker unit (5) therein, provided with peripheral speaker sound transmitter means (5.1), it would be possible to transmit various sound effects to the user's ears. For example, this effect transmitted to the user's ears can allow 5.1 and similar sound effects to be created as well.

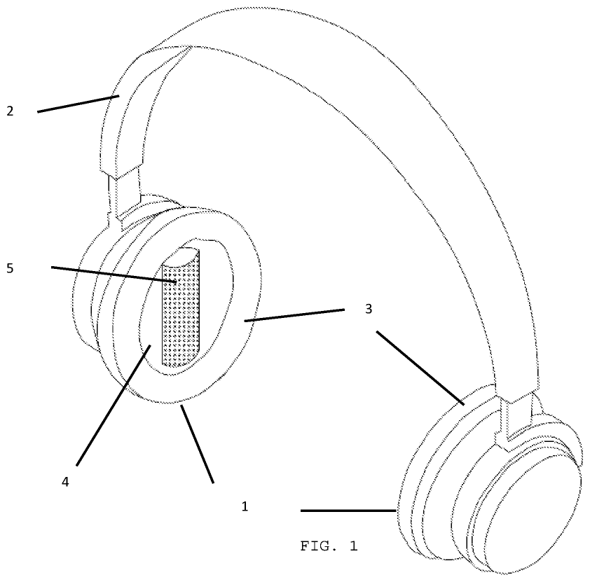

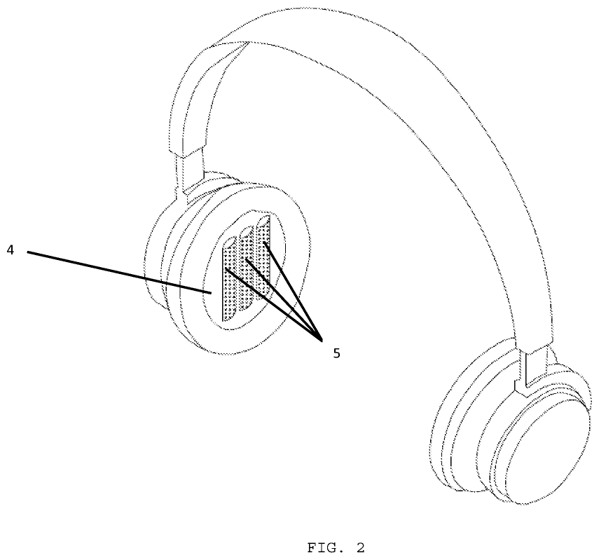

FIG. 1 shows the speaker unit (5) that is vertically positioned on the ear cup (4). In different embodiments of the invention, the speaker unit (5) can be positioned on the ear cup (4) in various orientations including horizontal, angular, disorganized, etc.

The speaker unit (5) can be designed in different geometric shapes suitable to create surround sound effects. According to another embodiment of the invention, the speaker unit (5) can be designed to be spherical by being peripherally provided with the speaker sound transmitter means (5.1). FIG. 6 illustrates an embodiment of the headphones in which said headphones have speaker units (5) designed to be in a spherical shape.

An aim of the speaker units (5) described in the scope of the invention is to create surround sound effects. In order to achieve this aim, the speaker units (5) can respectively be provided with at least a speaker sound transmitter means (5.1) that are peripherally formed. While the speaker sound transmitter means (5.1) may define a single peripheral line, they can be designed to be suitable to cover the entire lateral circumference of the speaker unit (5), as shown in FIG. 3.

If the speaker units (5) are peripherally provided with speaker sound transmitter means (5.1), the sound would be allowed to be created peripherally and thus the sound created by the speaker sound transmitter means (5.1) positioned toward the placement openings (6) can also be reflected toward the user's ears through said placement openings (6).

To this end, the placement openings (6) and/or the ear cup (4) can be completely or partially covered by the parts that help or enable the sound to be reflected.

As the speaker units (5) that are able to create surround sound reflect the sound created toward the placement openings (6) and/or the ear cup (4), such sound would act on the user's ears as well. In this way, the surround sound effect can be transmitted to the user's ear. This reflection effect created on ears, for example, can allow the user to experience an ambiance such that they are in a concert hall.

According to another embodiment of the invention, the placement openings (6) are provided with a connection member that both enables data connection and fastens the speaker unit (5) onto the placement openings (6). In a further embodiment of the invention, the connection member is a USB connection.

In various embodiments of the invention, various connection members would be encompassed within the scope of the invention.

For example, in a case where a USB inlet is provided in the placement openings (6), the speaker unit (5) can also be provided with a USB outlet suitable to fit in said USB inlet for connection. With the USB connection, both the speaker unit (5) can receive data and also the speaker unit (5) can be fastened onto the placement openings (6).

The headphones according to the invention can be used by having said headphones rest over the ears while the ear units (1) or the speaker units can be used as external sound transmitters by being opened to emit sounds to the environment in which the user is located.

In this case, the user can use the embodiment subject to the invention as headphones, on the other hand, they can utilize said embodiment as an external sound generator to emit sounds to the given environment.

What is claimed is:

1. Over-ear headphones, comprising
ear units placed on two opposite ends of an elastic headband,
speaker units positioned to create a sound in a direction of an ear cup in the ear units,
placement openings and/or ear cups completely or partially covered by elements helping or enabling a sound to be reflected,
wherein at least a speaker unit of the speaker units is provided on the ear cup of an ear unit of the ear units, the speaker unit is provided with speaker sound transmitter means having at least one peripheral portion in each ear unit to allow a user to experience a surround sound effect.

2. The over-ear headphones according to claim 1, comprising at least a cylindrical speaker unit for the each ear unit peripherally provided with the speaker sound transmitter means on lateral walls of the cylindrical speaker unit.

3. The over-ear headphones according to claim 1, comprising at least a prism-shaped speaker unit for the each ear unit peripherally provided with the speaker sound transmitter means on lateral walls of the prism-shaped speaker unit.

4. The over-ear headphones according to claim 1, comprising at least a spherical-shaped speaker unit for the each ear unit peripherally provided with the speaker sound transmitter means over an entire external area of the spherical-shaped speaker unit.

5. (canceled)

6. The over-ear headphones according to claim 1, wherein the speaker unit is vertically positioned on the ear cup in relation to a ground plane.

7. The over-ear headphones according to claim 1, wherein the speaker units is mounted on the ear unit in an undetachable manner.

8. The over-ear headphones according to claim 1, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.

9. The over-ear headphones according to claim 8, comprising a USB connection member.

10. The over-ear headphones according to claim 2, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.

11. The over-ear headphones according to claim 3, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.

12. The over-ear headphones according to claim 4, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.

13. The over-ear headphones according to claim 5, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.

14. The over-ear headphones according to claim 6, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.

15. The over-ear headphones according to claim 7, wherein
the placement openings are provided with a first connection member, wherein the first connection member both enables a data connection and fastens the speaker unit onto the placement openings, and
the speaker unit is provided with a second connection member wherein the second connection member both allows the speaker unit to be fastened onto the placement openings and provides the data connection for the speaker unit.
